(19) United States
(12) Patent Application Publication
(10) Pub. No.: US 2026/0209602 A1
(43) Pub. Date: Jul. 23, 2026

(54) A mulch composition and uses thereof

(71) Applicant: Luonnonvarakeskus, Helsinki (FI)

(72) Inventors: Kimmo Rasa, Helsinki (FI); Marleena Hagner, Helsinki (FI)

(21) Appl. No.: 19/139,381

(22) PCT Filed: Dec. 18, 2023
(86) PCT No.: PCT/FI2023/050709

§ 371 Date: Jun. 16, 2025

(30) Foreign Application Priority Data
Dec. 20, 2022 (FI) 20226129

(51) Int. Cl. C09K 17/52; A01G 13/35

(52) U.S. Cl. CPC C09K 17/52; A01G 13/35

(57) ABSTRACT

According to an example aspect of the present invention, there is provided a mulch composition comprising: a fibrous organic waste material and/or a fibrous organic side-stream material, and a liquid derived from thermochemical decomposition of biomass, wherein said mulch composition is configured to solidify, upon being distributed over a soil substrate or a growing medium substrate, to form a surface cover layer thereon.

### FIELD

The present application relates to layered organic ground cover materials, such as mulches and their production methods. In particular, the present application concerns a mulch material typically implemented as a biodegradable fluidic composition, a method for its production and related uses.

### BACKGROUND

Various soil and plant cover materials, generally known as mulches/mulch ground covers, are available to assist cultivation. Use of mulches/mulch ground covers provides for necessary soil warmings, soil moisture regulation, enhanced nutrient management, reduced root pruning and improved plant growth.

Synthetic mulch ground covers are commonly produced of plastic. Each year about 80 000 km² of cultivated lands worldwide are covered by plastic ground cover films, made primarily of black polyethylene. Synthetic plastic materials do not degrade promptly and must be removed after each crop rotation. However, removal of the plastic from the site is rather problematic, since used mulches readily break into small pieces. Thus, plastic waste increase microplastics in the environment. Moreover, used plastic mulches are not suitable for recycling because loads of dirt and soil stuck thereto. Their efficient disposal via burning is associated with environmental hazards and significant expenses, whereas reclamation via burying, for example, is laborious and long-lasting. Moreover, use of plastic mulches does not allow for efficient application of additional fertilizers, as well as prevents uniform moisture distribution upon raining or irrigation, for example. Another common drawback associated with the use of plastic films is uncontrolled entrance and propagation of insects, snails, worms, etc. thereunder.

Biodegradable mulch ground covers, such as paper, carton, fabric, or biodegradable plastic (polylactic acid derived, for example) are also known. These ground covers are, however, generally incapable of regulating soil temperature. Paper mulches tend to break apart easily; therefore those cannot be used as efficient weed controls means. Since about 30-40% of crop losses worldwide are caused by uncontrolled weed growth, importance of providing efficient weed control means cannot be underestimated.

Other solutions include particulate mulches derivable from natural sources, including plant residues, wood products and animal material. Those are particularly suitable for cultivation of so-called natural or organic products, generally known as organic farming; however, efficiency of said nature-derived mulches against uncontrolled weed growth is low.

The aforementioned solutions, although generally usable, are still restricted with two common drawbacks. Apart from the above indicated problems arising from utilization of plastic ground cover films prevailed in at least some crop cultivation regions worldwide, the other major drawback concerns an abundant use of synthetic chemicals along with the mulch materials. Thus, in order to efficiently prevent weed growth, only in Finland in 2020 about 1,200 tons of effective agents have been sold for agricultural, horticultural and forestry purposes, wherein about a half of total chemicals sold has been glyphosate and the products based thereon. The European Commission approved a proposal for banning polyethoxylated tallow amine (POEA), a co-formulant, from all glyphosate-based herbicides, in 2016 due to its high toxicity. Use of glyphosate as an active ingredient is currently approved in EU until 15^{th} of December 2022 and its use in Europe tends to decrease. European Union Farm to Fork and Biodiversity—strategies and Plant Protection Product Directive (2009/128/EC) provides the range of actions to reduce the risks and impacts of pesticide use on human health and the environment. The goal is to reduce the “overall use and risk” of chemical pesticides by 50% by 2030.

In this regard, it would be desirable to update the field of technology related to production of mulches and mulch ground covers in view of reducing environmental risks associated with the use plastic mulches and pesticides, and the like, as well as decreasing compromising effects thereof onto soils and crops. In particular, in view of global climate change and the current warming trend, pronounced growth of weeds and pest insects must be foreseen and prepared to combat with by means other than hazardous chemicals. Need for new, environmentally sustainable weed- and pest control substances arises also in city planning and landscaping, e.g. in public green recreation zones, parks and playgrounds. Further advances in development of synthetic plastic-free mulches are also highly looked-for. Moreover, provision of means for facilitating distribution of mulch materials within cultivated areas is still desirable. It would be very desirable to discover a solution that supports circular economy in which waste streams form industry are used rather than disposed. The current way to dispose for example fibre sludge side stream created in paper industry is incineration together with e.g. bark side streams. However, incineration of fibre sludge may have even disadvantageous impact on incineration process, and thus alternative usages for this side streams have been suggested (Oksanen et al. 2022). Various biomasses with similar challenges are generated in the agriculture and industry.

WO2018108681 discloses a biodegradable mulch composition based on a peat material.

There are several problems related to the use of peat in mulch composition. First, peat is not considered as an environmentally friendly material and there is a pressure to reduce its use. Second, peat is not readily available in all countries and there is a pressure to reduce the use of native peat resources, which is limiting its use. Third, peat softens during rainy season and cracks when it dries thus allowing weed growth.

### SUMMARY OF THE INVENTION

An objective of the present invention is to at least alleviate the problems arising from the limitations and disadvantages of the related art. The objective is achieved by various embodiments of a mulch composition, a method for manufacturing and uses thereof. Thereby, in one aspect of the invention a mulch composition is provided, according to what is defined in claim 1.

The invention is defined by the features of the independent claims. Some specific embodiments are defined in the dependent claims.

According to a first aspect of the present invention, there is provided a mulch composition comprising: a fibrous organic waste material and/or a fibrous organic side-stream material, and a liquid derived from thermochemical decomposition of biomass. Preferably said mulch composition is configured to solidify, upon being distributed over a soil substrate or a growing medium substrate, to form a surface cover layer on said substrate.

According to a second aspect of the present invention, there is provided a method for producing the mulch composition according to the first aspect, the method comprising the steps of: providing the fibrous organic waste material and/or the fibrous organic side stream material in the form of an aqueous suspension, followed by admixing liquid derived from thermochemical decomposition of biomass into the said suspension, to obtain the mulch composition.

According to a third aspect of the present invention, there is provided a ground cover for a soil substrate or a growing medium substrate, the ground cover comprising the mulch composition according to the first aspect in the form of a surface cover layer distributed over the soil substrate or the growing medium substrate.

According to a fourth aspect of the present invention, there is provided use of the mulch composition according to the first aspect as a pesticidal composition.

According to a fifth aspect of the present invention, there is provided use of the mulch composition according to the first aspect for plant protection in agriculture, horticulture, forestry, gardening, green building and/or landscaping.

According to a sixth aspect of the present invention, there is provided use of the mulch composition according to the first aspect for soil reclamation and/or soil improvement.

According to a seventh aspect of the present invention, there is provided use of the mulch composition according to the first aspect as a physical barrier layer on a soil substrate or a growing medium substrate.

According to an eight aspect of the present invention there is provided use of a fibrous organic material comprising recycled fibres, a fibrous sludge and/or a food industry fibrous waste material in a mulch composition.

Various embodiments of any one of the above aspects may comprise one or more features from the following bulleted list:
The mulch composition is a fluidic mulch composition.
The mulch composition is a liquid mulch composition.
The mulch composition is in the form of a liquid suspension, such as an aqueous suspension.
The mulch composition is a flowable mulch composition.
The mulch composition forms a uniform structure, such as a uniform layer, over the soil or the growing medium surface.
The mulch composition comprises the fibrous organic waste material and/or the fibrous organic side-stream material in an amount in the range 2 to 20 wt-%, calculated from the total mass of the mulch composition, preferably in the range 2 to 10 wt-%, for example in the range 4 to 6 wt-%.
The mulch composition comprises the liquid derived from thermochemical decomposition of biomass in an amount in the range 1 to 40%, preferably in the range 1 to 30%, most preferably in the range 2 to 25%, expressed as percent of the total volume occupied by the mulch composition.
The liquid derived from thermochemical decomposition of biomass is a water-soluble liquid, such as a water-soluble liquid fraction of a liquid product obtained from biomass feedstock by thermochemical decomposition.
The liquid derived from thermochemical decomposition of biomass comprises pyrolysis liquid or a fraction thereof.
The liquid derived from thermochemical decomposition of biomass comprises torrefaction liquid or a fraction thereof.
The liquid derived from thermochemical decomposition of biomass comprises a liquid fraction from hydrothermal carbonization of biomass.
The thermochemical decomposition is performed by pyrolysis.
The thermochemical decomposition is performed by torrefaction.
The thermochemical decomposition is performed by hydrothermal carbonization.
The liquid derived from thermochemical decomposition of biomass is substantially tar-free.
The liquid derived from thermochemical decomposition of biomass comprises less than 6 wt-%, such as less than 2 wt-% polycyclic aromatic hydrocarbons, calculated from the total mass of the liquid.
The mulch composition further comprises at least one additive provided as a biochar.
The mulch composition further comprises one or more additives from the following group: bio-ash, bark, wood chips, bark powder, bark chips, lignin-based products, other biomasses and/or additive chemicals.
The mulch composition comprises a plant-based fibrous additive, which has a different composition than the fibrous organic waste material and the fibrous organic side-stream material.
The mulch composition comprises less than 10 wt-%, such as less than 2 wt-% peat, calculated from the total mass of the mulch composition.
The surface cover layer comprises a uniform surface cover layer of a predetermined depth.
The durability of the composition is one growing season.
The fibrous organic waste material and/or the fibrous organic side-stream material has been derived from pulp or paper industry.
The method comprises mixing the fibrous organic waste material and/or the fibrous organic side-stream material with water to obtain an aqueous suspension.
The method comprises admixing at least one additive with the fibrous organic waste material and/or the fibrous organic side-stream material prior to combining the resulted blend with water.
The additive comprises biochar.
The additive is selected from the group consisting of bio-ash, bark, wood chips, bark powder, bark chips, lignin-based products, and any combinations thereof.
The pesticidal composition is any of the following: a herbicidal composition, a fungicidal composition, a bactericidal composition, an insecticidal composition, an insect growth regulating composition, a nematocidal composition, a molluscicidal composition, and a rodenticidal composition.

The utility of the present invention arises from a variety of reasons depending on each particular embodiment thereof.

At first, the invention generally aims at solving the problem of plastic waste, arising from the used ground cover films commonly made of polyethylene. The mulch composition provided hereby typically comprises only organic components and therefore may be completely biodegradable. It is clear that degradation of organic matter proceeds in significantly shorter time periods in comparison to synthetic materials; therefore the mulch composition according to the present invention can be left on the field after harvesting, or under plants or between rows for example in horticulture or landscaping applications, thus improving cost-efficiency of the cultivation cycle(s). Since the invention preferably does not rely on petroleum-derived plastic polymers, utilization thereof has no harmful effects onto activity and population of soil microorganisms and does not give rise to environmental damages at cultivation sites.

Second, the mulch composition disclosed hereby may possess a marked potential as a physical cover material or can be used a pesticide. The mulch composition may act as a natural repellent against pest insects, snails, slugs, etc., and, in some instances, against harmful microorganisms and small rodents. Moreover, the mulch composition may be effectively used to combat an uncontrolled weed growth. Repelling effect lasts normally for at least several weeks dependent on raining conditions. Since the mulch composition of the present invention preferably does not contain any synthetic chemicals, it is safe to use in public green recreation zones, such as country parks and playgrounds. The mulch composition disclosed hereby may further promote plant and seedlings growth due to pest prevention properties thereof. The mulch composition of the present invention may be environmentally friendly and biocompatible.

Another important factor to consider, in terms of nowadays popular “organic farming”, is an ability of the mulch composition of some embodiments of the present invention to improve resistibility or durability of crops and plants treated thereby against plant diseases, that logically eliminates the need in obtaining transgenic (genetically modified, GM) cultures. The invention thus may offer an efficient route for cultivating genetically unmodified plants in reasonable expenses that would make organic farming more competitive in terms of cost-effectiveness.

It is also noteworthy that the present invention may have beneficial effects on the soil structure and may improve nutrient retention in the soil.

For example, fibre sludge, such as pulp fibre sludge, which may be part of the composition disclosed herein, may improve soil structure and reduce soil erosion related nutrient leaching from agricultural clay soils when mixed with the soil (Rasa et al. 2020). The pulp fibre sludge further may contribute to building up soil organic matter and thereby favour soil carbon sequestration at least in decadal time span (Rasa et al. 2020; Heikkinen et al. 2021). In addition, the mulch composition of some embodiments may allow water and oxygen to pass through.

Furthermore, since in some embodiments the invention does not involve any kind of a plastic film to cover soil, rain water and irrigation water can penetrate therethrough, which thus may improve efficiency of drip irrigation systems. Some embodiments may allow getting rid of various pest insects, snails, etc. that commonly nest under plastic (or any kind of sheet-like) ground cover films. The mulch composition disclosed hereby may also possess excellent oxygen permeability characteristics.

In addition to aforesaid, the mulch composition of some embodiments is provided in a substantially fluidic, liquid-like form. Hence, it is easy to spread within a cultivated area, in particular within otherwise difficult-to-reach zones, such as around and/or under individual plants, bushes, seedlings, under perennial plants and berry plants, as well as between plant rows.

In some embodiments, the mulch composition may be a liquid suspension, such as an aqueous suspension. Preferably, the mulch composition is flowable.

A particular advantage of the mulch composition of some embodiments is that the mulch composition may solidify to form a rather hard composition which does not lose its structure in rainy weather or crack when it dries. Both softening of the structure and the cracks would allow weed growth through the mulch.

Advantageously, the mulch composition is easily spreadable over the soil substrate for example by means of a hose pipe and thus can be applied to many different kinds of surfaces, even to ones that are difficult to reach or have rough surfaces. After spreading, the mulch composition usually solidifies and forms a ground cover. The solidified cover may not lose its structure during rainy weather or crack when it dries and thus it may prevent growth of weeds very efficiently.

Another important benefit to consider is that the mulch composition of some embodiments may enhance development of circular economy by providing new uses for different side streams and products derived from biomass processing. For example, fibre sludge is typically derived as a side stream from pulp and paper industry and is currently disposed by incineration. Some embodiments of the present invention may enable to take it into use instead of incineration. Liquids from thermochemical processing, on the other hand, may contain many valuable chemical components, but their commercial utilization is currently scarce or even considered as a barrier for utilization of the technologies.

Therefore, the present liquid mulch composition may facilitate development of circular bioeconomy by providing new uses for various biomass-based fractions derived from biomass processing operations. Typically such fractions are considered as side streams. Some embodiments of the present invention may facilitate their value-added utilization in line with premises of circular bioeconomy.

### BRIEF DESCRIPTION OF THE DRAWINGS

FIG. 1 illustrates the effect of mulching materials on the growth of weeds. PLM refers to pyrolysis liquid mulch.

FIG. 2 illustrates the effect of mulching materials on the growth of trees. PL refers to pyrolysis liquid.

FIG. 3 illustrates the day and night temperatures in control plots without mulching and plots mulched with either peat or fibre sludge based mulch.

FIG. 4 illustrates the relative moisture content at −6 cm depth in the soil in control plots and mulched with either peat or fibre sludge based mulch.

FIG. 5 illustrates plant coverage in variously treated plots.

FIG. 6 illustrates cracking of different mulch compositions and colour adjustment of fibre sludge mulch composition.

### EMBODIMENTS

### Definitions

In the present context, the term “a fibrous organic waste material and/or a fibrous organic side-stream material” refers to fibrous organic material derived from waste materials and/or side stream materials from industrial processes.

The fibrous organic waste material and/or the fibrous organic side stream material may be chemically or mechanically derived for example from pulp, paper and wood processing industry, food industry, textile industry or agriculture.

Examples of materials falling into the meaning of the term “a fibrous organic waste material and/or a fibrous organic side stream material” comprise for example fibre sludge, deinked pulp, recycled paper and organic growing media. The chemical and physical properties of the fibrous organic waste material and/or the fibrous organic side stream material varies depending on the source of the material.

In some embodiments, the fibrous organic waste material and/or the fibrous organic side-stream material comprises fibre sludge.

In some embodiments, the fibrous organic waste material and/or the fibrous organic side-stream material comprises recycled paper and/or paperboard.

In some embodiments, the fibrous organic waste material and/or the fibrous organic side-stream material comprises deinked pulp.

In some embodiments, the fibrous organic waste material and/or the fibrous organic side-stream material comprises organic growing media.

For example, the properties of fibre sludge derived from the pulp and paper industry varies mainly depending on the used wood materials, processing technologies and their set up in the individual factory, and targeted final products. In general, fibre sludges are rich in organic matter, but the content of cellulose, hemicellulose, lignin as well as nutrients vary. The dry matter content of for example the fibre sludge may be approximately 30% after a thickening procedure.

The fibrous organic waste materials derived from other biomass materials vary also on their macro molecular and chemical composition. Typically, the organic matter content of these materials is high with variable water content depending on the origin of the material.

In some embodiments, the fibrous organic waste material and/or the fibrous organic side-stream material has been derived from pulp or paper industry.

In some embodiments, the fibrous organic waste material and/or the fibrous organic side-stream material has been derived from food industry.

As used herein, the term “fibrous” refers to any material comprising fibres. A fibre is a natural or synthetic substance for which the diameter is significantly smaller than the length. Examples of fibres comprise cellulosic and/or lignocellulosic fibres. For example, fibre sludge derived from pulp may comprise, as main constituents, cellulosic fibres, hemicellulose, optionally lignin, and optionally nutrients.

In an embodiment, the composition of a nutrient-poor fibre sludge from pulp industry may comprise the components as shown in Table 1.

TABLE 1

| | EC | nitrogen | | | | |
|---|---|---|---|---|---|---|
| | (electrical | as NH₄ | nitrogen | phosphorus | total | |
| | conductivity) | mg/kg fw | as NO₃ | as PO₄ | nitrogen | |
| | 10⁻⁴ S/cm | (fresh weight) | mg/kg fw | mg/kg fw | mg/kg fw | pH |
| Fibre sludge | 1.5 | 14.9 | 6.1 | 2.3 | 34.7 | 8.6 |

In some embodiments, the average fibre length in the fibrous organic waste material and/or the fibrous organic side stream material is above 100 μm, such as above 300 μm.

The term “biomass” is utilized in present disclosure with regard to a plant-based material, typically available on renewable basis, including products of agriculture and forestry, as well as residues and waste from wood-, paper and food industries.

The terms “natural”, “organic” and “bio-derived” are utilized in present disclosure to indicate that the material in question is directly derivable from renewable biomass sources.

The term “biocompatible” is used to indicate that the material in question has no toxic or hazardous effects on environmental and ecological systems.

The term “biodegradable” is used to indicate that the material in question can be completely broken down by micro-organisms found in the environment in a reasonable timeframe.

The term “ground cover” is typically utilized in present disclosure to indicate a formation established upon the aforesaid mulch composition has been uniformly spread over a soil substrate within a site intended for treatment or at least a part of said site, to form a uniform surface cover layer of a predetermined thickness (depth).

The term “liquid derived from thermochemical decomposition of biomass” is typically utilized in the present disclosure with regard to a water-soluble liquid product obtainable from thermochemical decomposition of biomass feedstock. The product is in some instances a pre-fractionated product. The biomass feedstock may be for example a further fibrous organic waste material and/or a further fibrous organic side-stream material.

“Thermochemical decomposition” comprises any method in which decomposition is performed by heating the material and wherein a liquid product is produced thereof. Preferably, thermochemical decomposition is performed with limited or low supply of oxygen, most preferably in the absence of oxygen. Thermochemical decomposition can also be referred to with the terms “thermal decomposition” or “thermolysis”. Examples of methods falling within the meaning of “thermochemical decomposition” include slow pyrolysis, torrefaction and hydrothermal carbonization.

The term “biochar” refers in present disclosure to a solid product obtained by thermochemical decomposition of biomass. Biochar is formed primarily from the thermochemical conversion of lignocellulosic material, in particular, lignin. In addition, char or biochar can be derived from carbon capture technologies. Char, or biochar, is composed mainly of carbon, preferably comprising at least 20 wt-%, such as 20 to 99.9 wt-% carbon.

Biomass may also contain a small mineral content that is converted, upon thermochemical decomposition, into ash. Said ash is further referred to as “bio-ash”.

The present application discloses a liquid or fluidic mulch composition comprising a fibrous organic material, which is a waste and/or side stream material, and a liquid derived from thermochemical decomposition of biomass. The composition is configured to solidify, upon being distributed over a soil substrate or a growing medium substrate, to form a surface cover layer on said substrate. In some embodiments, the mulch composition forms a uniform surface cover layer over the soil or the growing medium surface. Preferably, the surface cover layer is of a predetermined depth.

Typically the mulch composition is not provided in the form of a web but instead is provided in the form of a flowable mulch composition that forms a solidified surface cover layer only after being spread onto said substrate.

The mulch composition may be distributed over a soil substrate or a growing medium substrate.

The mulch composition may be uniformly distributed over a soil substrate, such as clay. The mulch composition spread over the soil substrate thus forms on said soil substrate a ground cover provided as a surface cover layer of a predetermined thickness (depth). Thickness of said ground cover layer may be in the range 0.2 to 3 cm, such as 1 to 2 cm, such as approximately 2 cm or for example approximately 1 cm.

It is preferred that the fluidic mulch composition is easily spreadable over the soil substrate by means of a hose pipe, for example. It is further preferred that said mulch composition is configured to solidify, upon being distributed over a soil substrate, to form a uniform surface cover layer of a predetermined depth.

In some preferred embodiments, the mulch composition comprises the fibrous organic waste material and/or the fibrous organic side stream material in an amount of 20 to 60 wt-% of the total mass of the mulch composition. Preferably, the amount of the fibrous organic waste material and/or the fibrous organic side stream material is in the range 2 to 20 wt-%, such as 2 to 10 wt-%, such as 3 to 8 wt-%, for example 4 to 6 wt-%. Most preferably, the amount of the fibrous organic waste material and/or the fibrous organic side stream material in the mulch composition is around 5 wt-%. Exact percentage from the total volume may depend on the moisture content in said fibrous organic waste material and/or the fibrous organic side stream material.

The amount of the fibrous organic waste material and/or the fibrous organic side stream material is preferably low enough so that the composition is flowable and can thus be easily spread over the soil substrate. On the other hand, the amount of the fibrous organic waste material and/or the fibrous organic side stream material is preferably high enough so that the composition can solidify upon being distributed over a substrate and can form a surface cover layer on the substrate.

The water content of the mulch composition may be at least 30 wt-%, such as at least 40 wt-%, such as at least 50 wt-%, such as at least 60 wt-% from the total weight of the mulch composition. In some embodiments, the water content of the mulch composition may range from 20 to 95 wt-%, such as 30 to 80 wt-%, of the total weight of the mulch composition. Typically, the water content of the mulch composition is less than 98 wt-%, such as less than 95 wt-% of the total weight of the mulch composition. In some embodiments, the solids content of the mulch composition may be less than 60 wt-%, such as less than 50 wt-%, such as less than 40 wt-%, such as less than 30 wt-%, such as 2 to 20 wt-% of the total weight of the mulch composition.

The fibrous organic material to be included in the mulch composition may have variable moisture contents.

In some embodiments, the fibrous organic waste material and/or the fibrous organic side stream material has a moisture content of less than 80 wt-%, such as less than 50 wt-%.

In some embodiments, the fibrous organic waste material and/or the fibrous organic side stream material is in a substantially dry form, having a moisture content (such as water content) in the range 1 to 20 wt-%, for example 1 to 10 wt-%, calculated from the total weight of the material.

In some instances, the amount of moisture in the fibrous organic waste material and/or the fibrous organic side stream material may be less than or equal to 5 wt-%. The material, according to this embodiment, may be provided in particulate (dried, unprocessed) or powdered (dried and processed by grinding, for example) forms.

In other embodiments, the fibrous organic waste material and/or the fibrous organic side stream material may be pre-saturated with water or may have a high initial moisture content so that the moisture content therein is at least 50 wt-%, such as 50 to 80 wt-%.

The mulch composition is preferably thick and viscose enough so that it stays as a layer on top of the soil and can function as a mulch. Therefore, it is preferred that the water content in the fibrous organic waste material does not exceed 80 wt-%, calculated from the total mass of the fibrous organic waste material.

In some instances, “wet” or freshly collected sludge fibres can be utilized as the fibrous organic waste material. In these cases, it is preferred that the fibrous organic waste material is thickened before mixing it with the liquid, to obtain the mulch composition.

Thickening may be performed by any means suitable for thickening. For example, water may be partially removed from the fibrous organic waste material by any suitable means, such as filtering, decantation or evaporation. In other examples, water content is reduced with thickening additives, such as biochar.

In accordance to the definition above, the term “biomass” is utilized hereby primarily to indicate lignocellulosic (“green” or plant) biomass, incorporating wood, grass, and other herbaceous material, as well as wood-, food- or paper-derived waste biomass. The main components of lignocellulosic biomass are cellulose, hemicellulose and lignin. For example, wood contains about 35 to 50 wt-% of cellulose, 20 to 30 wt-% of hemicellulose and 25 to 30 wt-% lignin. Other typical components are extractive substances provided as generally smaller organic molecules or polymers, and minerals (inorganic compounds). These are present in varying proportions in different biomass types, which proportions influence product distributions upon thermochemical decomposition.

The mulch composition comprises liquid derived from thermochemical decomposition of biomass. In some embodiments, the thermochemical decomposition is performed by pyrolysis. In other embodiments, the thermochemical decomposition is performed by torrefaction. Yet in other examples, the thermochemical decomposition is performed by hydrothermal carbonization or liquefaction.

Pyrolysis is a process of thermochemical decomposition of organic material in an absence or limited amount of oxygen. Pyrolysis of biomass normally yields volatile non-condensable gases (H₂, CO, CO₂, CH₄, CₙHₘ), solid (bio)char, and volatile condensable compounds, wherein the latter can condensate to form liquids. Upon heating to pyrolysis temperatures, cellulose and hemicellulose form condensable vapours and gases, whereas lignin decomposes to liquid, gaseous and solid char products.

Step-wise pyrolysis refers to a process in which pyrolysis products can be separated based on temperature regimes. For instance, pyrolysis liquid can be obtained from temperature regime 0 to 350° C. Biochar production on the other hand continues to temperatures up to 800° C.

“Torrefaction” of biomass refers to a mild form of pyrolysis wherein final process temperatures are typically between 22° and 350° C. Torrefaction is typically carried out at atmospheric pressure with low oxygen concentration or in the absence of oxygen. During a torrefaction process, the water contained in the biomass is removed, and the biopolymers which make up the high-solids biomass (for example cellulose, hemicellulose and lignin) partly decompose, giving off various types of volatiles. Torrefaction thus yields water, volatile organic compounds and a solid, dry, blackened material which may be referred to as “torrefied biomass” or “biochar”. The volatile organic compounds may be condensed to a liquid product.

“Hydrothermal carbonization” refers to a process where organic compounds are converted to carbons in the presence of heat, water and high pressure. Typically the temperature during hydrothermal carbonization ranges from 180° C. to 350° C. The pressure is preferably in the range of about 10 to 80 bar during hydrothermal carbonization. The precise process conditions, such as temperature, pressure and time, may depend on both the organic compounds and the target yield and characteristics of the products.

Aforesaid (condensable) liquid products are generally referred to as pyrolysis liquids, wood vinegar, pyroligneous acids, bio-oils or pyrolysis tars. Chemical composition of said pyrolysis liquids largely depends on a type of biomass it is produced from; amount of various components there within may reach hundreds. Pyrolysis liquids can be subjected to further separation or refinement, for example by fractional distillation to obtain various distillate fractions.

In some embodiments, the liquid derived from thermochemical decomposition of biomass is a water-soluble fraction of the liquid product obtained from biomass feedstock by pyrolysis. Unfractionated pyrolysis liquid is a dark brown, tarry, free-flowing organic liquid with low pH value (pH 2 to 3) and comprised of highly oxygenated compounds. Pyrolysis liquid typically contains a considerable amount of compounds that act as natural adhesives to bind the fibrous organic waste material, as discussed herein below.

In preferred embodiments, the liquid mulch composition comprises the liquid product derived from thermochemical decomposition of biomass in an amount ranging between 1 to 40 percent of the total volume occupied by the mulch composition (vol-%). Preferably, the amount of liquid product derived from thermochemical decomposition of biomass in the mulch composition is 1 to 30 vol-%, most preferably 2 to 25 vol-%.

The amount of liquid derived from thermochemical decomposition of biomass in said mulch composition is generally adjustable depending on the weed pressure and tolerance capacity of the plant. By the way of an example, concentrations of the liquid products derived from thermochemical decomposition of biomass expressed as a volumetric fraction of the total volume of the fluidic mulch composition constitute: 3 to 4 vol-% for short-season vegetables (harvested in 1 to 2 months); 5 to 6 vol-% for one-season vegetables and perennial herbs; 7.5 to 10 vol-% for berry crops; and 10 to 25 vol-% for multi-season greenspace trees and ornamentals.

By adjusting amounts or sources of liquid product derived from thermochemical decomposition of biomass in the mulch composition, physical properties thereof, such as density, viscosity and flowing ability, can be regulated to render said mulch composition particularly suitable for a variety of site-related applications, such as for fruit- and vegetable gardens, fields, parks and forests. For example, viscosity of the mulch composition may be reduced and flowing ability increased, accordingly, whether intended use thereof is a difficult site, for example under individual plants and bushes, as well as between the plant rows. Also functional properties of the mulch composition can be regulated in the same manner, as discussed herein below.

It is generally known that the content of a liquid product formed during pyrolysis of biomass is affected by temperature and resident time of the reactions. Pyrolysis processes can be roughly categorized to slow pyrolysis and fast pyrolysis.

Fast pyrolysis is typically characterized by high heating rates (about 1000° C./s), temperatures generally in the range of 450 to 800° C., and short vapour residence time (less than 2 seconds). This generally requires dry and finely grinded feedstock.

Slow pyrolysis typically runs at temperatures in the range 350 to 800° C., in some instances in the range 400 to 500° C., has slow heating rates and longer vapour residence times. In some embodiments, the vapour residence time is at least 2 seconds. Slow pyrolysis is also more tolerant to moisture content in feedstock. Slow pyrolysis process attracts special interest, since it appears to have a greater impact on decreasing the rate of climate change due to a higher share of (bio)char produced thereby that can work as a carbon sink and increase agricultural productivity of soils.

In an embodiment, the slow pyrolysis is carried out in a temperature of 350 to 800° C., such as 350 to 500° C. or 400 to 500° C.

In an embodiment, the slow pyrolysis is carried out by applying a vapour residence time of at least 2 seconds, such as at least 5 seconds.

For the purposes of the invention it is preferred that liquid product derived from thermochemical decomposition of biomass in the mulch composition is produced by slow pyrolysis or torrefaction.

Liquid derived from thermochemical decomposition of biomass obtainable by the methods of slow pyrolysis generally consists of an organic (water-soluble) liquid phase and tars chemically dissolved therein. The reference is made particularly to pre-fractionated liquid that has undergone separation of tar/oil fraction. The tar/oil fraction is separated for example by settling down by simply storing during several weeks or by water addition (25 to 30%).

Torrefaction liquid can be used directly without fractionation.

Stepwise slow pyrolysis approach can be used to fractionate pyrolysis liquid based on temperature as explained in Hagner et al. (2020) and Korkalo et al (2022). Briefly, temperature fractionation typically means that pyrolysis liquid is derived from a temperature regime below for example 350° C., and the process is continued to higher temperatures to produce biochar.

Pyrolysis liquid can be considered to be a microemulsion in which the continuous phase is an aqueous solution of cellulose and hemicellulose decomposition products and small amount of molecules from lignin decomposition. The main compounds of the water-soluble liquid phase are water and organic components, such as acetic acid, methanol, hydroxypropanone, furfural and acetone. Other organic compounds of the liquid phase include, but are not limited to the other carboxylic acids, e.g. formic acid; syringol, guaiacol, catechol, and phenol derivatives; benzenes; heterocyclic organic compounds, such as furans and pyrans; sugar-like compounds, for example 1,6-anhydro-β-D-glucopyranose; and polycyclic aromatic hydrocarbons (PAHs). Tars, in turn, primarily consist of PAH compounds and high molecular lignin-based substances, the latter constituting 50 to 60 wt-% of the tar(s).

One advantage with using only the water-soluble liquid phase is that it is substantially tar-free and does not contain polycyclic aromatic hydrocarbon (PAH) compounds that are cumbersome during handling of the material. However, PAH compounds do not restrict the use of the pyrolysis liquid in the much composition. In some preferred embodiments, the amount of polycyclic aromatic hydrocarbons is less than 10 wt-%, such as less than 6 wt-%, such as less than 5 wt-%, such as less than 3 wt-%, or less than 1 wt-%.

In one preferred embodiment wood feedstock is utilized for obtaining said pyrolysis liquid. By the term “wood feedstock” we primarily refer to the products of forestry and wood waste. Characteristics of wood pyrolysis products are dependent on whether a hardwood or softwood species are pyrolyzed. In the present disclosure a reference is made to broadleaf trees to identify the term “hardwood”, and to coniferous trees to identify the term “softwood”, accordingly.

The liquid derived from thermochemical decomposition of biomass for the liquid mulch solution may be produced from all types of biomasses. The thermochemical decomposition process itself may be optimized to obtain a good-quality liquid with for example a high acid concentration.

In a still further embodiment, a hardwood-derived biomass is utilized as a feedstock. Exemplary hardwood tree species include that of genus Betula (birch), such as B. pendula (Silver birch), B. pubescens (Downy birch); genus Salix (willow), such as S. caprea (Goat willow), S. borealis (Boreal willow), S. pentandra (Bay-leaf willow); genus Acer (maple), such as A. platanoides (Norway maple); genus Ulmus (elm), such as U. glabra (Wych elm), U. laevis (European white elm); genus Quercus (oak), such as Q. robur (Common oak), and the like genus Populus (aspen), such as Populus tremula, genus Eucalyptus (eucalyptus).

Hardwood and softwood species vary in their cellulose, hemicellulose and lignin composition. In contrast to softwood, hardwood hemicelluloses are primarily composed of xylan, and to a lesser extent, glucomannan and pectin. In the slow-pyrolysis of lignocellulosic biomass, hemicelluloses are the most important precursors in pyrolysis liquid production. The chain structure of xylan consists of xylose (Xyl) units with an O-acetyl group attached to 7 out of 10 xylose units and 4-O-Me-glucuronic acid to 1 out of 10 xylose units. The O-acetyl groups of xylan are precursors of acetic acid formed in thermochemical conversion. Therefore, in the production of pyrolysis liquid the proportion of xylan may be utilized as a decisive characteristic of the biomass in terms of the composition of the produced pyrolysis liquid.

In some embodiment the mulch composition further comprises at least one additive.

The additive is preferably provided as biochar. Biochar may provide a desired colour to the mulch composition. In addition, biochar may stabilize the mulch composition.

Additional examples of suitable additives are bio-ash, bark, wood chips, bark powder, bark chips, lignin-based products, other biomasses and/or additive chemicals. In specific examples the additives are derived from biomass. In some preferred embodiment the biochar, bio-ash and bark are wood-derived.

Said additive is preferably provided as a fine ground particulate or a powder. The content of the additive in the mulch composition may vary within the range of 1 to 15 wt-%, such as 3 to 12 wt-%, for example 5 to 10 wt-%. Preferably, the amount of additives is less than 15 wt-%, calculated from the total mass of the mulch composition.

In some examples, the mulch composition further comprises peat. Preferably the peat concentration is less than 10 wt-%.

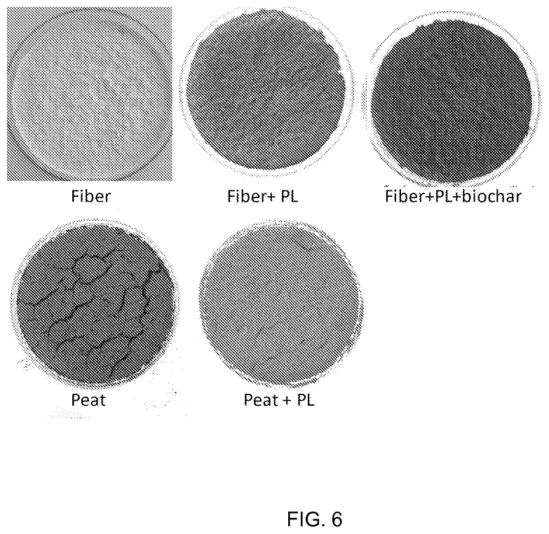

The colour of fibre sludge material is light. In some embodiments the colour of the mulch composition may be adjusted with additives (FIG. 6, upper row). Examples of suitable additives are bio-char, bio-ash, bark chips and bark powder. Such coloured mulch composition may be more suitable for certain applications where visual appearance is important. The colour of the mulch composition depends on the amount of the added additive and the colour of the added additive. A lighter colour is achieved with smaller concentration of the additive.

Upon provision of the mulch composition with deprived light permeability due to addition of biochar or other additives therein the following benefits can be attained: improved thermal storage capacity (soil-warming capacity) in the soil surface layer due to addition of a black colour to the mulch composition; improved weed control due to decreased light penetration through the mulch composition layer; improved soil water holding/retention capacity; improved soil fertility due to enhanced carbon uptake and sequestration, as well as due to addition of soil organic matter (SOM) content; and absorption of noxious chemicals

In some embodiments, the mulch composition forms a uniform surface cover layer of a predetermined depth. The depth of the surface cover layer may be in the range 0.5 to 5 cm, preferably 1 to 3 cm, such as about 2 cm.

The mulch composition provided hereby may be completely biodegradable under conventional environmental conditions. Degradation or biodegradation of liquid derived from thermochemical decomposition of biomass typically occurs within a time period of several weeks to months from application of said composition onto the soil. In some embodiments, the expected durability of the mulch composition is one growing season. Provision of the mulch composition is usually therefore such as to enable complete integration thereof with any kind of ecosystem, thus allowing for sustainable agriculture and forestry in an improved manner, in terms of efficiency and biocompatibility.

In some embodiments, a method for producing the mulch composition is provided. The said method comprises at least: providing a fibrous organic waste material and/or a fibrous organic side stream material in the form of an aqueous suspension, followed by admixing the liquid derived from thermochemical decomposition of biomass into the said suspension, to obtain the mulch composition.

In some embodiments, the method comprises an additional step of admixing at least one additive, typically with any of said materials.

In some embodiments, the method comprises combining the fibrous organic waste material and/or the fibrous organic side stream material with water to obtain an aqueous suspension. In other embodiments, the method comprises an additional step of admixing at least one additive with the fibrous organic waste material and/or the fibrous organic side stream material, prior to combining a resulted blend with water.

In some embodiments, the additive is biochar.

In other embodiments, the additive is bio-ash, bark, wood chips, bark powder, bark chips, lignin-based products or any combination thereof.

Additional examples of additives comprise other biomasses or chemical substances providing for example a desired colour for the product or affecting the surface tension or durability of the product.

Other biobased materials or side streams, such as side streams from food processing industry, may be used as additives, for example to modify the colour, outlook or durability of the mulch composition.

Preferably, the amount of such additive is less than 15 wt-% calculated from the total mass of the mulch composition.

The colour of the mentioned additives may be adjusted according to need.

The method allows for producing a substantially liquid mulch composition that is easily spreadable over the soil substrate by means of a hose, for example.

It is preferred that the dry components, viz. the fibrous organic waste material and the at least one additive, are pre-combined prior to admixing water thereto. For the purposes of the invention the term “dry” is utilized hereby to indicate substantially moistureless, particulate, fibrous or powdered material, in which moisture content is at most 10 wt-%, in some instances, at most 5 wt-%.

It is further preferred that the liquid derived from thermochemical decomposition of biomass is added after water has been admixed with the fibrous organic waste and/or side stream material and, optionally, additive(s). In one particular example, dry fibre sludge material derived from pulp, according to some embodiment, has been admixed with finely ground (dry) additive, such as biochar, and water has been added to a resulting dry blend to obtain an aqueous suspension. Preparation of the mulch composition has been completed by further admixing of liquid derived from thermochemical decomposition of biomass into said aqueous suspension.

Admixing of liquid derived from thermochemical decomposition of biomass into the aqueous fibrous organic waste and/or side stream material suspension thus constitutes a very last stage of the production method. The mulch composition can be prepared beforehand and transferred to a cultivation site as a ready-made composition. Alternatively, liquid derived from thermochemical decomposition of biomass can be added into the aqueous fibrous organic waste and/or side stream material suspension immediately on-site, prior to distribution of the mulch composition over the site intended for treatment.

Fibrous organic waste and/or side stream materials pre-saturated with water and/or freshly collected, according to some embodiments, are first admixed with water followed by addition of liquid derived from thermochemical decomposition of biomass, in accordance with the method disclosed above.

Upon admixing of liquid derived from thermochemical decomposition of biomass into the aqueous fibrous organic waste material suspension followed by spreading the resulted mulch composition onto a cultivated site, at least partial gelation of the mulch composition occurs, because liquid derived from thermochemical decomposition of biomass acts as glue that binds fibres in the fibrous organic waste material and, optionally, biochar or the other additive(s) to form a stable mass. Gelation or coagulation of the mulch composition occurs within several hours after application thereof onto soil.

Provision of the mulch composition is preferably such that said mulch composition can further form a mulch ground cover. A ground cover for the soil substrate or the growing medium substrate is hereby provided, comprising the mulch composition in the form of a surface cover layer distributed over said soil or growing medium substrate. Upon being applied onto the soil substrate or the growing medium substrate, the mulch composition thus forms a uniform ground cover layer of a predetermined thickness (depth) that can be adjusted according to a variety of parameters including, but not limited to cultivated vegetation/-plants, soil type, landscape, intended use, environmental factors, and the like. It is preferred that the aforesaid ground cover is approximately 1 to 3 cm thick. For those skilled in the art it is clear that the ground covers, formed by spreading the mulch composition over soil substrates, can be provided for the areas of practically any size, ranging from individual vegetable patches (for example 0.2 to 5 m²) to vast areas occupied by fields, recreation parks, forests and forest nurseries (for example 10 to 100 km²). Formation of ground covers for areas such as for households, playgrounds and other green building infrastructures can be also advantageously realized.

Solidification of the mulch composition and formation of the abovementioned ground cover occurs directly on-site (in open air), upon distributing the mulch composition over the soil substrate or the growing medium substrate. On the contrary, to sheet-like ground covers that could be successfully applied solely onto open flat surfaces, the ground cover of the present invention is applicable over a broken/rough terrain, over hillsides, below and under the bushes, tree nurseries, seeding trays, etc.

Various uses of the mulch composition are further provided. In one preferred embodiment, the mulch composition can be utilized to combat a variety of pests including, but not limited to: weeds, fungi, bacteria, insects, worms, caterpillars and the like, snails and slugs, as well as small rodents, such as rats, mice, voles, etc. Hereby use of the mulch composition as a pesticidal composition is provided, wherein the pesticide is selected from the group consisting of: herbicide, fungicide, bactericide, insecticide, insect growth regulator, nematocide, molluscicide, and rodenticide.

Pesticidal activities of the mulch composition thus include, but are not limited to prevention and control of pest reproduction, growth and propagation; destroying; repelling; inhibiting/disrupting life cycle and/or egg-laying ability; and disinfecting.

Pesticidal activity of the mulch composition may be typically or primarily imparted by the properties of liquid derived from thermochemical decomposition of biomass comprised thereto.

For example, as mentioned hereinabove, liquid derived from thermochemical decomposition of biomass may comprise, as primary components, acetic acid and furfurals, which typically exhibit pesticidal activity. Furfural, for example, may function as a pesticide because of its nematicidal and antifungal activities.

An effective amount of liquid derived from thermochemical decomposition of biomass in the mulch composition, in terms of inducing an observable pesticidal effect thereby, is preferably experimentally adjusted for each plant type and/or an intended use of the composition (e.g. in agriculture, horticulture, forestry, etc.).

In an embodiment, at least 1 vol-% of liquid derived from thermochemical decomposition of biomass is included in the mulch composition. Such a mulch composition may be used for example in vegetable patches.

In an embodiment, at least 5 vol-% of liquid derived from thermochemical decomposition of biomass is included in the mulch composition. Such as mulch composition may be used in applications with high weed pressure, such as around park trees and in forest nurseries.

In some embodiments, the mulch composition may be used for plant protection in agriculture, horticulture, forestry, gardening, green building and/or landscaping.

Additionally, the mulch composition may improve plant resistibility or durability against plant diseases.

The mulch composition can be further used in reclamation and/or improvement of soil(s). Distribution of the mulch composition over the soil substrate within a site intended for treatment, such as a field, for example, enhances and/or deepens an existing organic matter containing soil layer, recovers and/or improves soil structure and stimulates activity of soil microorganisms' therewithin.

In some embodiments, the mulch composition may be used as a physical barrier layer on a soil substrate or a growing medium substrate.

In addition, in some embodiments the use of a fibrous organic waste material and/or a fibrous organic side stream material in mulch composition is provided. The material may comprise recycled fibres or fibrous sludge from pulp or food industry fibrous waste.

### EXPERIMENTAL SECTION

### Example 1

A mulch for forest tree nursery is produced by mixing water (140 L), fibre (60 L), pyrolysis liquid (8 L) and possible additives. The mixing is conducted in a container using for example a twist drill. At first, fibre and water are mixed (for about 3 min, 300 rpm), and thereafter pyrolysis liquid and additives are added (about 2 min, 300 rpm). The obtained mulch is easy to spread in liquid form. The total solid content of the mixture is approximately 5 wt-% calculated from the total mass of the mulch composition, but may vary, typically in the range 2 to 20 wt-%, largely depending on the raw materials and additives used.

### Example 2

Plots were randomly treated either by 2 cm layer (i.e. 20 L/m²) of (1) peat+pyrolysis liquid (PL) mulch, (2) fibre sludge+PL or (3) left without mulching (=control). Two weeks after the mulching the seedlings of birch (Betula pendula), spruce (Picea abies) and pine (Pinus sylvetris) were potted in six rows and five lines producing 30 seedlings of each species per plot. Altogether the experiment contained thirty-six experimental squares (1.17 m×1.3 m) consisting of four replicate blocks (A to D), three tree species and three treatments randomly allocated in each block.

The effects of mulches on soil temperature and moisture were measured from the middle of pine growing squares (n=4). In control plots, weeds were calculated, uprooted, dried and weighed at 4 and 12 weeks after mulching. In peat+PL and fibre sludge+PL plots, no weeds were grown in week 4 and thus weeds were uprooted only at week 12.

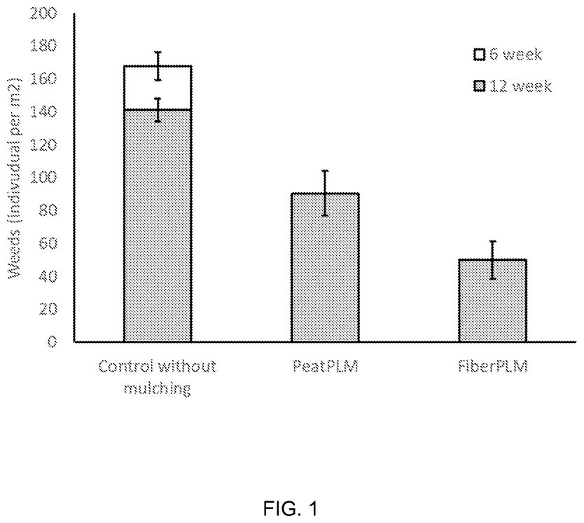

In controls there were on average 168 weed individual/m², peat based mulch contained 90 ind./m² and in fibre based mulch 50 ind./m² (FIG. 1). The fibre sludge based solution was more efficient in weed control than the peat based solution. It is also likely that fibre sludge based solution is more durable than the peat based solution. Based on visual observation, cracking in the peat based mulch was higher than in the fibre sludge based solution (FIG. 6). Cracking increased the growth of weeds.

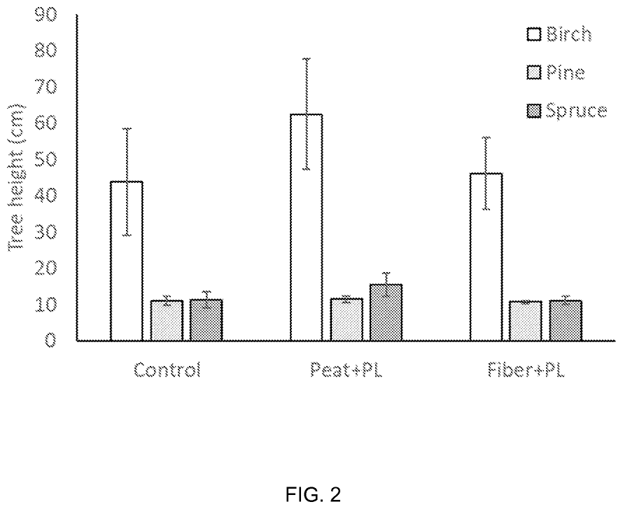

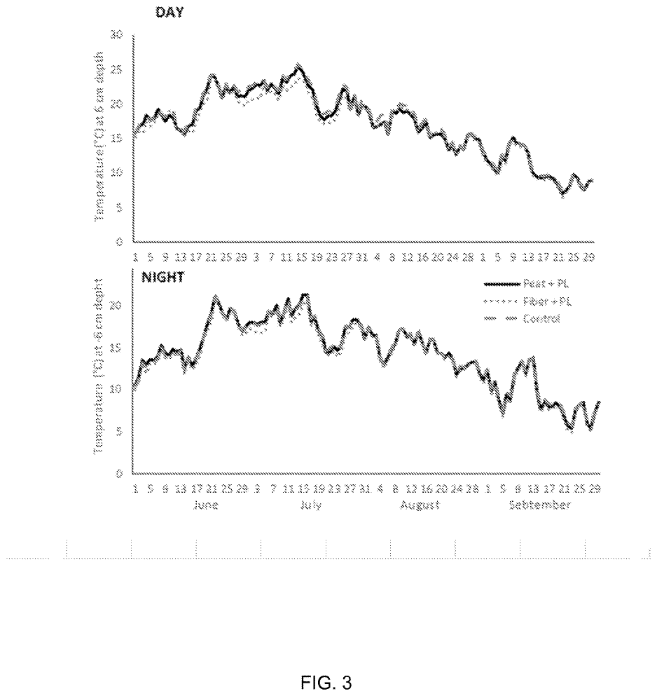

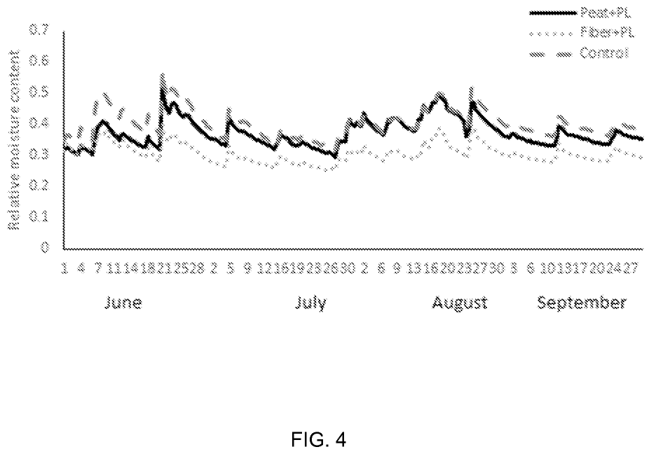

Treatments had no effect on tree growth, i.e. plants grow as well in mulched than in control plots (FIG. 2). No clear effects on soil temperature was observed over the experimental period (FIG. 3). The relative soil moisture remained favourable over the experimental period, because no differences in three growth was observed. However, moisture content in the fibre sludge based treatment was slightly lower than in the other treatments (FIG. 4). This phenomenon might be explained by lower crack formation in fibre sludge based solutions leading to solid cover, which restricts both weed growth and percolation of water through the mulch layer. This feature could be beneficial in arid areas were drip irrigation (below the mulch layer/next to plant root) is used to save limited water resources.

### Example 3

Experiment was established in turf site growing various grass species and consisted of 25 (1 m×1 m) plots. Treatments were 1) control without mulching, 2) peat, 3) peat+PL, 4) fibre sludge material and 5) fibre sludge material+PL each having five replicates in random order. Plots were covered with 10 to 15 L of mulching material. Coverage of grasses was monitored at 2, 4, 6 and 8 weeks after the treatments.

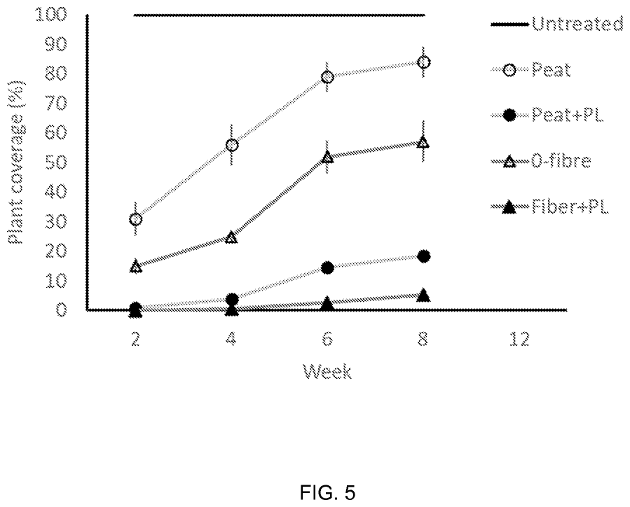

Grass coverage in control plots remained at 100% during experiment. Peat and fibre sludge material without PL addition reduced plant coverage by forming a hard cover preventing plant growth but the effect decreased over time. Application of PL to peat and fibre sludge material increased plant eliminating effect, the fibre sludge material based mulch being significantly more efficient than the peat based (FIG. 5).

The experiment on perennial grassland demonstrated the weed control capability of fibre sludge mulch in demanding circumstances (perennial grass is a strong competitor). There was clear indication that pyrolysis liquid is a substantial part of the solution. Both examples demonstrate that use of fibre sludge material as an ingredient in mulch improves the performance of the mulch.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Unless otherwise stated, properties that have been experimentally measured or determined herein have been measured or determined at room temperature. Unless otherwise indicated, room temperature is 25° C.

Unless otherwise stated, properties that have been experimentally measured or determined herein have been measured or determined at atmospheric pressure.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### CITATION LIST

### Non-Patent Literature

Rasa, K., Pennanen, T., Peltoniemi, K., Velmala, S., Fritze, H., Kaseva, J., Joona, J., Uusitalo, R. 2020. Pulp and paper industry sludges decrease soil erodibility. Journal of Environmental Quality, 50. 172-184. https://doi.org/10.1002/jeq2.20170.
Hagner, M., Tiilikkala, K., Lindqvist, I., Niemelä, K., Wikberg, H., Källi, A., Rasa, K. 2020. Performance of liquids from slow pyrolysis and hydrothermal carbonization in plant protection. Waste and Biomass Valorization 11:1005-1016 https://doi.org/10.1007/s12649-018-00545-1
Heikkinen, J., Ketoja, E., Seppänen, L., Luostarinen, S., Fritze, H., Pennanen, T., Peltoniemi, K., Velmala, S., Hanajik, P., and Regina, K. 2021. Chemical composition controls the decomposition of organic amendments and influences the microbial community structure in agricultural soils, Carbon Management, 12:4, 359-376, DOI: 10.1080/17583004.2021.1947386
Korkalo, P., Hagner M., Jänis, J., Mäkinen, M., Kaseva, J., Lassi, U., Rasa K., Jyske T. 2022. Pyroligneous acids of differently pretreated hybrid aspen biomass: herbicide and fungicide performance. Frontiers in Chemistry 9:821806 https://doi.org/10.3389/fchem.2021.821806
Oksanen, J., Keskinen, R., Heikkinen, J., Kaseva, J., Rasa, K. 2022. The Effects of Mixing Pulp and Paper Mill Sludge Into Wood Bark on Storage-Related Environmental Impacts and Heating Value. Waste and Biomass Valorization, 13. 3573-3584. https://doi.org/10.1007/s12649-022-01716-x.

### Patent Literature

WO2018108681

1. A mulch composition comprising:
a fibrous organic waste material and/or a fibrous organic side-stream material, and
a liquid derived from thermochemical decomposition of biomass,
wherein said mulch composition is configured to solidify, upon being distributed over a soil substrate or a growing medium substrate, to form a surface cover layer thereon.

2. The mulch composition according to claim 1, wherein the mulch composition forms a uniform structure on the surface of said substrate.

3. The mulch composition according to claim 1, wherein the mulch composition comprises the fibrous organic waste material and/or the fibrous organic side-stream material in an amount in the range 2 to 20 wt-%, calculated from the total mass of the mulch composition.

4. The mulch composition according to claim 1, wherein the mulch composition comprises the liquid derived from thermochemical decomposition of biomass in an amount in the range 1 to 40%, expressed as percent of the total volume occupied by the mulch composition.

5. The mulch composition according to claim 1, wherein the liquid derived from thermochemical decomposition of biomass is a water-soluble liquid of a liquid product obtained from biomass feedstock by thermochemical decomposition.

6. The mulch composition according to claim 1, wherein the thermochemical decomposition is pyrolysis, torrefaction or hydrothermal carbonization.

7. The mulch composition according to claim 1, wherein the liquid derived from thermochemical decomposition of biomass comprises pyrolysis liquid.

8. The mulch composition according to claim 1, wherein the durability of the composition is one growing season.

9. The mulch composition according to claim 1, wherein the fibrous organic waste material and/or the fibrous organic side-stream material has been derived from pulp or paper industry.

10. The mulch composition according to claim 1, wherein the fibrous organic waste material and/or the fibrous organic side-stream material comprises fibre sludge from pulp or paper industry.

11. The mulch composition according to claim 1, wherein the mulch composition is a flowable mulch composition.

12. The mulch composition according to claim 1, wherein the mulch composition is a liquid mulch composition.

13. A method for manufacturing the mulch composition according to claim 1, wherein the method comprises the steps of:
providing the fibrous organic waste material and/or the fibrous organic side-stream material in the form of an aqueous suspension, followed by
admixing the liquid derived from thermochemical decomposition of biomass into said suspension, to obtain the mulch composition according to claim 1.

14. A ground cover for a soil substrate or a growing medium substrate, wherein the ground cover comprises the mulch composition according to claim 1 in the form of a surface cover layer distributed over the soil substrate or the growing medium substrate.

15-17. (canceled)

18. The mulch composition according to claim 3, wherein the mulch composition comprises the fibrous organic waste material and/or the fibrous organic side-stream material in an amount in the range 2 to 10 wt-%, calculated from the total mass of the mulch composition.

19. The mulch composition according to claim 1, wherein the mulch composition has a water content of 30 to 80 wt-%.

20. The mulch composition according to claim 1, further comprising at least one additive selected from the group consisting of biochar, bio-ash, bark, wood chips, bark powder, bark chips, lignin-based products and any combination thereof.

21. The mulch composition according to claim 1, further comprising at least one additive in an amount of 1 to 15 wt-%.

22. The mulch composition according to claim 1, wherein the liquid derived from thermochemical decomposition of biomass is substantially tar-free.

23. The mulch composition according to claim 1, wherein the mulch composition comprises less than 10 wt-% peat, calculated from the total mass of the mulch composition.
